(19) United States
(12) Patent Application Publication
(10) Pub. No.: US 2025/0102087 A1
(43) Pub. Date: Mar. 27, 2025

(54) APPARATUS AND METHOD FOR PIPE REPAIR

(71) Applicant: David Romero, Dinuba, CA (US)

(72) Inventor: David Romero, Dinuba, CA (US)

(21) Appl. No.: 18/974,718

(22) Filed: Dec. 9, 2024

Related U.S. Application Data
(62) Division of application No. 17/076,583, filed on Oct. 21, 2020.

(51) Int. Cl. F16L 13/11; F16L 55/175

(52) U.S. Cl. CPC F16L 13/11; F16L 55/175

(57) ABSTRACT

The methods and devices described herein are for repairing a break in a pipe and also provide means for adding additional pipes to an existing pipe. According to a first embodiment, a pair of end connectors are installed on the broken ends of a pipe and then a sleeve is slid over the gap between the two broken ends. According to a second embodiment, two half cylinder connector pieces are placed around a broken pipe and then a cylindrical sleeve is placed over the top. According to a third embodiment, two half cylinder connector pieces are glued to each other and the broken pipe, one of the half cylinders having a branch for installing an additional pipe to the pipe system.

### CROSS-REFERENCE TO RELATED APPLICATIONS

This application is a divisional of U.S. patent application Ser. No. 17/076,583, filed Oct. 21, 2020, incorporated herein by reference in its entirety.

### TECHNICAL FIELD

The disclosure relates to a method and apparatus for repairing a broken or cut pipe.

### BACKGROUND

Pipes are used for a variety of different purposes in commercial and residential construction. For example, water, gas, electrical wires, heating and air conditioning and sewage are conducted through pipes. These pipes can be composed of varied materials such as plastics or metals.

A pipe used for utilities can be broken accidentally during construction, landscaping, or repair of nearby infrastructure. Current methods for repairing a broken pipe are laborious and can narrow the cross-section of the pipe. Narrowing the cross-section of the pipe can restrict the amount of material conducted by the pipe.

Sometimes a pipe is intentionally cut to access the contents inside of the pipe. Repairing a pipe in this situation is difficult, especially if there are wires running through the pipe and a repairer cannot cut the wires to finish the repair. Current methods for repairing a pipe with wires running through require many pieces and a lot of labor and are difficult to fit into tight spaces.

Lastly, a pipe may be cut to add one or more junctions to the pipe. Current methods require several pieces and lots of effort cutting and gluing different pieces of pipe together.

### BRIEF DESCRIPTION OF THE DRAWINGS

FIG. 1 is a perspective view of a pipe repair system.

FIG. 2 is a perspective view of an end connector of the pipe repair system.

FIG. 3 is a perspective view of a sleeve of the pipe repair system.

FIG. 4 is a side view of the sleeve of the pipe repair system.

FIG. 5 is a top view of a pipe repair system installed on a broken pipe.

FIG. 6A is a perspective view of two separated connector pieces of the pipe repair system.

FIG. 6B is a perspective view of two joined connector pieces of the pipe repair system.

FIG. 7A is an end view of two joined connector pieces of the pipe repair system.

FIG. 7B is a detail view of the edge of a connector piece of the pipe repair system.

FIGS. 8A and 8B show the two connector pieces surrounding a broken or cut pipe.

FIG. 8C shows the two connector pieces joined together around a broken or cut pipe.

FIGS. 9A, 9B, and 9C show the sleeve moving into place over the two connector pieces to form a tight connection over the broken or cut pipe.

FIGS. 10A and 10B show a t-shaped connector piece for adding an additional branch to a cut pipe.

FIG. 11 describes a method for using the pipe repair system.

FIG. 12 describes a method for repairing a broken pipe using two connector pieces.

FIG. 13 describes a method for inserting a t-shaped connector into a pipe.

### DETAILED DESCRIPTION

A pipe that is broken or intentionally cut can be difficult to repair when the pipe is in-situ. A pipe is in-situ if it is buried in the earth or installed within a building or other location where the pipe has already been incorporated into the infrastructure.

One particular problem of repairing an in-situ pipe is access. A pipe that needs to be repaired can be difficult to access if it is buried in the earth or located in a building where there is not enough clearance around the pipe to easily work on the pipe.

An additional complication is that the pipe may be in service at the time that it needs to be repaired. A pipe is in service if a substance is flowing or running through it. Pipes can be used to conduct liquids, gasses, wires or other substances. When the pipe is in service it may be difficult to interrupt the service to repair the pipe. If the pipe has active wires running through the pipe, the wires cannot be cut to repair the pipe. Pipes are used in commercial and residential applications.

Current methods for repairing a cut or broken pipe are laborious requiring multiple pieces that must be measured, cut and glued into place. A previous method for repairing a pipe involves wrapping the pipe with a leak proof material or a rubber gasket and then clamping that material onto the pipe. A second existing method is to install a new section of pipe with fittings on both ends to secure it to the pipe. The section of pipe must be cut to a precise length and fitted with appropriately sized fittings to securely repair the pipe.

Existing methods for repairing a broken or cut pipe do not always provide a water tight connection. A water tight connection is desirable because a pipe may be carrying potable water or sewage. If the water is potable having a leak may contaminate the water. A leak in a sewage pipe would contaminate the surrounding area. A water tight connection is desirable in many instances because water seeping into the pipe could damage the contents of the pipe, such as electrical wires.

The pipe repair system described herein is quick to install and provides a sealed connection between the two broken ends of the pipe. Two embodiments are described below. In the first embodiment end connectors are placed on the ends of the broken pipe and then a sleeve is slid over the top to seal the connection between the two pipe ends. In the second embodiment, two connector pieces that are each a half cylinder in shape are placed around the broken pipe and then a sleeve is slid over the two connector pieces securing the connection.

The pieces of the pipe repair system can be manufactured in any size so that they correspond to the size of the broken pipe. Repair pieces that correspond with standard pipe sizes are envisioned but repair pieces can also correspond to non-standard pipe sizes. The pieces of the pipe repair system can also be made from any suitable material for repairing a pipe, such as plastic or metal.

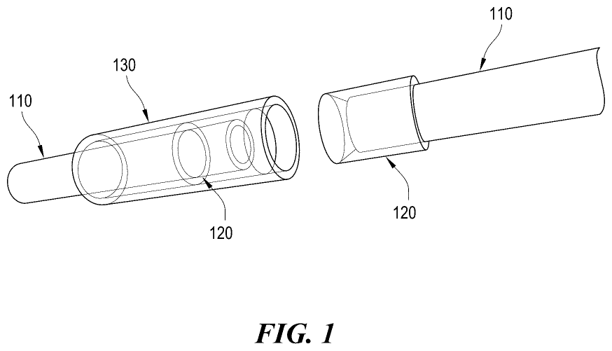

FIG. 1 is a perspective view of a first embodiment of the pipe repair system. A broken pipe 110 is fitted with two end connectors 120 and a sleeve 130 is slid over the two end connectors 120. The end connectors 120 can be of any size suitable to fit the broken pipe 110 being repaired. The end connectors 120 fit snuggly on the ends of the broken pipe 110. The sleeve 130 slides over the top of the broken pipe 110, covering the two end connectors 120.

The end connectors 120 are connected to the broken or cut pipe 110 by an adhesive, cement or other bonding agent. The sleeve 130 is bonded to the end connectors 120 by an adhesive, cement or other bonding agent. The fully formed connection, once the end connectors 120 and the sleeve 130 have been bonded onto the broken pipe 110, provides a sealed connection that can withstand the pressure of water or gas or another substance flowing through the pipe 110. The repair can also withstand forces from outside the pipe that might try to penetrate the repaired portion of the pipe, such as groundwater.

One embodiment of the invention is to repair a pipe that is in the ground. According to this embodiment the broken pipe 110 is exposed below the ground. It may be necessary to cut the ends of the broken pipe 110 so that they are even before repairing the break. The sleeve 130 is slid over one side of the broken pipe 110. Then, the end connectors 120 are installed on each end of the broken pipe 110. This includes placing an adhesive on the broken pipe 110 ends and/or on the end connectors 120 before they are inserted into the broken pipe 110 ends. An adhesive or some other type of bonding agent is placed on the outside of the end connectors 120 and then the sleeve 130 is slid over the top of the end connectors 120 so that the centerline of the sleeve 130 aligns with the centerline of the break in the pipe 110. Thus, the end connectors 120 and the sleeve 130 create a secure connection between the two ends of the broken pipe 110.

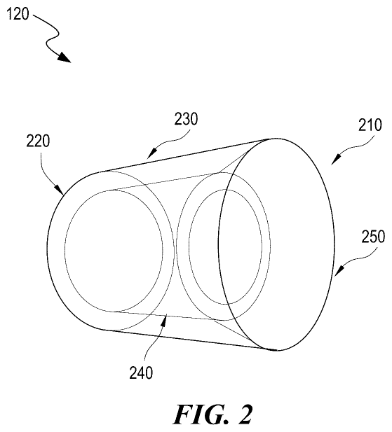

FIG. 2 is a perspective view of an end connector 120 of the pipe repair system. The open side 210 of the end connector 120 which faces away from the pipe 110 is concave thus allowing any fluid or wires or other items passing through the pipe 110 to move unimpeded through the repaired section. The side of the end connector 220 that sits on the pipe end has an inside diameter slightly larger than the broken pipe 110 and fits snuggly onto the broken pipe 110. The concave opening on the open side 210 is narrowest in the middle towards the broken pipe end 110 and opens outward to a lip 250 and is widest on the opposite side from the pipe 110.

According to one embodiment, the end connector 120 has an outer cylindrical surface 230 and an inner cylindrical surface 240. On the open side 210 of the end connector 120 that faces away from the pipe 110, the inner cylindrical surface 240 widens from the center towards the open side 210 resulting in a convex shape. The open side 210 of the end connector 120 that faces away from the pipe 110 is circular in shape and forms a narrow lip 250 thus guiding any substances flowing through the pipe 110 through the repaired section. On the pipe side 220 of the end connector 120 the inner surface of the end connector 120 is cylindrical and has a diameter slightly larger than the pipe 110 that the end connector 120 will be seated on. The pipe side 220 of the end connector 120 forms a circular end.

This design provides for a repair that does not narrow the cross section of the pipe 110. When the cross section of the repair is as wide as the broken pipe 110 then any substance flowing through the repaired pipe 110 is unimpeded. This helps to prevent clogs when the pipe 110 is in use. If the pipe 110 is being used to cover electrical wires, the broader cross section does not limit the number of wires that are passing through the pipe 110.

The sleeve 130 slides over the outside of the two end connectors 120. The position of the sleeve 130 on the outside of the end connectors 120 and the broken pipe 110 creates a larger diameter connection between the two ends of the in-situ pipe 110 and therefore does not limit the flow within the repaired pipe 110. The inside diameter of the sleeve 130 is only slightly larger than the outside diameter of the end connectors 120, thus providing a sealed connection once it has been glued on to the end connectors 120.

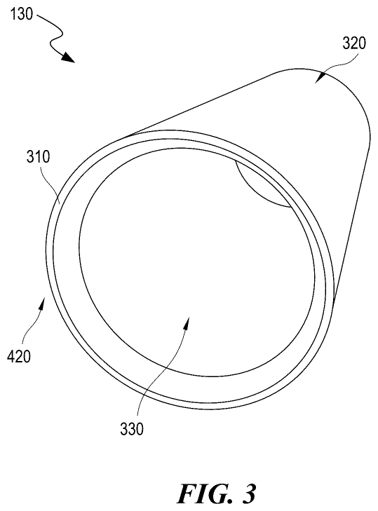

FIG. 3 is a perspective view of a sleeve 130 of the pipe repair system. The sleeve 130 is hollow so that it can pass over the end connectors 120 and the broken pipe 110. The edges 310 of the sleeve 130 are beveled so that the sleeve 130 can easily slide over the end connectors 120. The beveled edges 310 guide the sleeve 130 over the broken edges of the pipe 110 and then over the edge of the end connector 120 as the sleeve 130 is slid back over the end connectors 120 to seal the broken pipe 110 closed. The sleeve 130 can be made from any suitable material including plastic or metal. The sleeve 130 is manufactured to withstand any pressure that might be exerted on it by a substance traveling through the pipe 110. Also, the material of the sleeve 130, when appropriate, is resistant to corrosivity found in the environment in which the sleeve 130 will be installed including in the soil or any other location. The sleeve 130 is constructed of a substance that will adhere to a bonding agent so that a water tight seal can be formed between the sleeve 130 and the end connectors 120.

The sleeve 130 has an outer surface 320 and an inner surface 330. According to one embodiment, the sleeve is cylindrical in shape and the outer surface 320 is a cylinder with a larger diameter than the inner surface 330 which is also a cylinder.

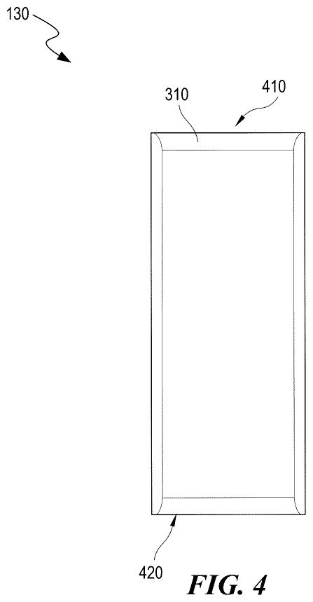

FIG. 4 is a side view of the sleeve 130 of the pipe repair system. The beveled edges 310 of the sleeve 130 are shown. The sleeve 130 is elongated to cover the end connectors 120 that are installed between the break in the pipe 110. The sleeve 130 can be bonded to the end connectors 120 to create a sealed connection closing the broken pipe 110.

The sleeve has a first end 410 and a second end 420. Each of these ends is circular in shape. The circular shape is best depicted in FIG. 3.

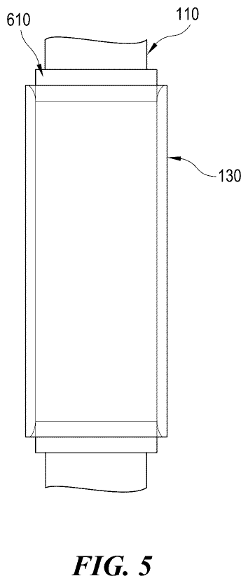

FIG. 5 is a top view of the pipe repair system installed on a broken pipe 110, according to a second embodiment. In this view only one of two connector pieces is visible. The connector piece 610 is mated with another connector piece and seated on the cut ends of the pipe 110 and then the sleeve 130 is slid in place over the top of the two connector pieces. The two connector pieces are bonded/glued to the ends of the broken pipe 110 and each connector piece is glued to the other connector piece. The sleeve 130 is bonded to the two connector pieces creating a sealed connection between the two ends of the broken pipe 110. Thus, the broken pipe 110 is repaired with a sealed connection.

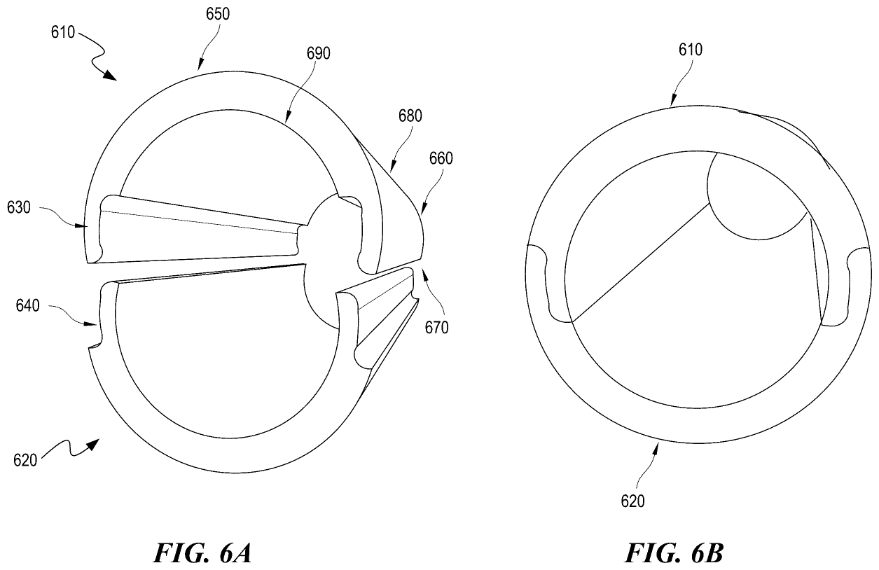

FIG. 6A is a perspective view of two separated connector pieces 610 and 620 of the pipe repair system, according to a second embodiment of the pipe repair system. According to this embodiment two connector pieces 610 and 620 are joined around a broken or cut pipe 110. The two connector pieces 610 and 620 are generally in the same shape as the broken pipe 110. The inside diameter of the joined connector pieces 610 and 620 is slightly larger than the outside diameter of the broken pipe 110.

Each connector piece 610 and 620, according to this embodiment, is a half cylinder in shape. Each connector piece 610 and 620 has a first end 650 and a second end 660. According to this embodiment, the first end 650 and the second end 660 are half circles in shape. The first end 650 and the second end 660 are half circles in shape to accommodate a circular pipe but can be shaped differently to adapt to a pipe of a different shape or for ease of manufacture.

Each connector piece 610 and 620 has an inner surface 690 and an outer surface 680. According to this embodiment, the inner surface 690 and the outer surface 680 extend from the first end 650 to the second end 660. The inner surface 690 corresponds to the shape of the pipe that the connector pieces 610 and 620 are installed around. In this embodiment the inner surface 690 is concave to accommodate a cylindrical pipe.

The connector pieces 610 and 620 are joined together around the broken pipe 110 on the long edge 670 of the half cylinder. The long edge 670 extends from the first end 650 to the second end 660. Each long edge 670 has a tab 630 extending out that engages with a tab 640 on the other connector piece 620, so that each connector piece 610 can click onto the other connector piece 620. The two connector pieces 610 and 620 joining together and clicking into place create a sealed connection around the broken pipe 110.

FIG. 6B is a perspective view of two joined connector pieces 610 and 620 of the pipe repair system. The two connector pieces 610 and 620 can be bonded to each other by placing glue where the tabs 630 and 640 are located and/or by gluing the two connector pieces 610 and 620 directly to the broken pipe 110. Gluing the two connector pieces 610 and 620 to the broken pipe 110 creates a sealed connection around the broken portion of the pipe 110.

The two connector pieces 610 and 620 can be placed at any orientation around the pipe 110, above, below, left, right or at oblique angles to the centerline of the pipe 110. For the purposes of describing the two connector pieces a top half 610 and a bottom half 620 are referenced but as previously mentioned they can be placed at any orientation. Tabs 630 on either long edge 670 of the top connector piece 610 meet with tabs 640 on either long edge 670 of the bottom connector piece 620. The tabs 630 and 640 join together creating a firm connection between the top connector piece 610 and the bottom connector piece 620.

According to one embodiment a pipe 110 is cut to gain access to wires inside of the pipe 110. Repairs are made within the pipe 110 then the pipe 110 must be repaired in a manner that seals the pipe 110 closed but leaves the wires running through the pipe 110 intact. The embodiment described here creates an easy water tight seal for repairing the pipe 110. The two connector pieces 610 and 620 are snapped around the broken pipe 110 and sealed to each other and to the two broken pipe halves 110 by a glue or other bonding agent.

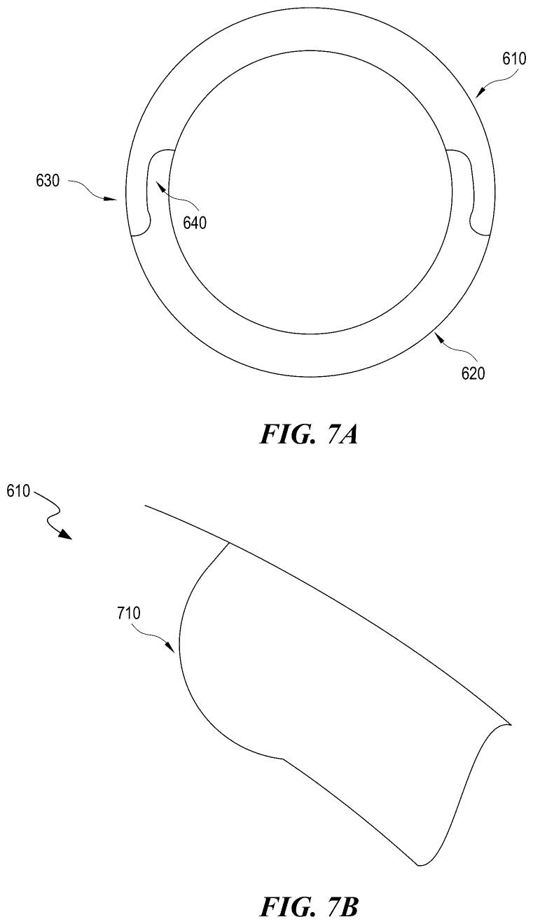

FIG. 7A is an end view of two joined connector pieces 610 and 620 of the pipe repair system. This embodiment shows the half circle interior of the connector pieces 610 and 620. The connector pieces 610 and 620 can take on any shape to fit the exterior of the pipe 110 being repaired. The two tabs 630 and 640 on either side of each connector piece 610 and 620 are also shown. The tabs 630 and 640 are joined together here creating a secure connection between the two connector pieces 610 and 620.

FIG. 7B is a detail view of the tab 630 of connector piece 610 of the pipe repair system. The tabs 630 and 640 have a slight protrusion 710 so that the ends can snap together. The tab 630 and 640 on each half also has a groove that corresponds with the protrusion so that the two halves fit snuggly together. Snapping the two connector pieces 610 and 620 together helps the ends to align more quickly and to form a firmer hold between the two connector pieces 610 and 620 of the pipe repair system.

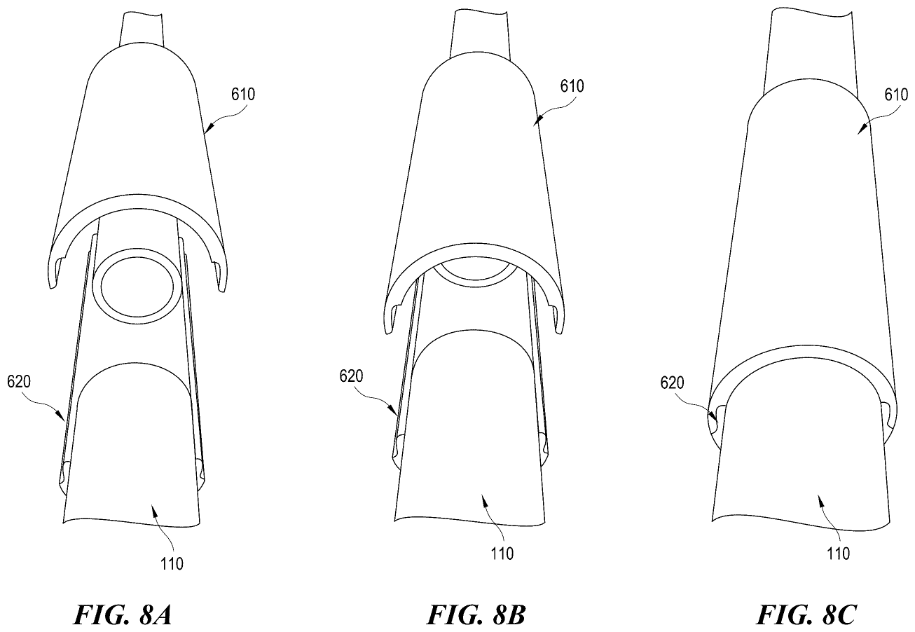

FIGS. 8A and 8B show the two connector pieces 610 and 620 surrounding a broken or cut pipe 110. FIGS. 8A and 8B depict how the two connector pieces 610 and 620 span a cut or broken area of the pipe 110. The pipe repair system creates a firm seal that does not diminish the cross-sectional area of the cut or broken pipe 110. A bottom connector piece 620 is placed below or on the side of the pipe 110. Then the top connector piece 610 is placed above or on the other side of the pipe 110. The two connector pieces 610 and 620 are then joined together. The tabs 630 and 640 clicking together to form a sealed connection.

FIG. 8C shows the two connector pieces 610 and 620 joined together around a broken or cut pipe 110. The two connector pieces 610 and 620 can be sealed together and to the pipe 110 using an adhesive or another type of bonding agent. An adhesive or a bonding agent provides a water tight seal between the two connector pieces 610 and 620 and the broken pipe 110.

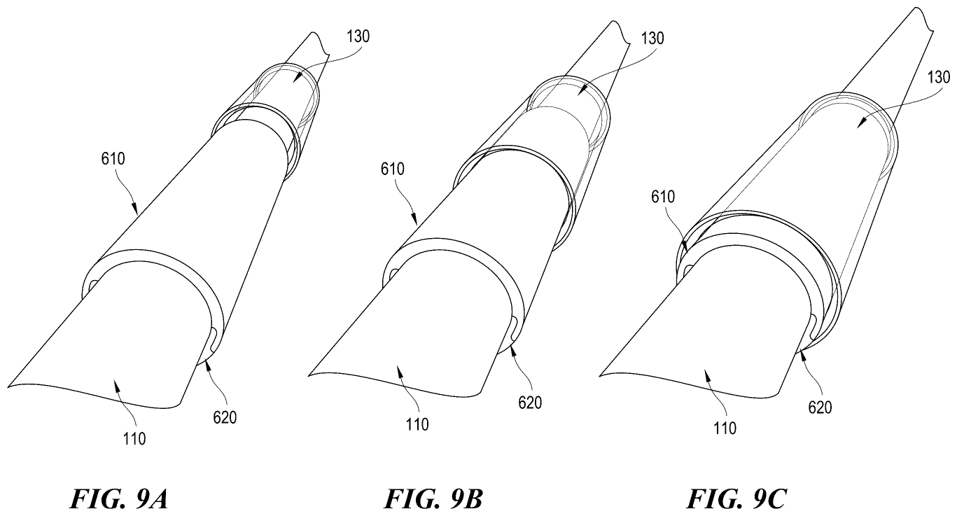

FIGS. 9A, 9B, and 9C show the sleeve 130 moving into place over the two connector pieces 610 and 620 to form a tight connection over the broken or cut pipe 110. The sleeve 130 can be installed over the two connector pieces 610 and 620 to help seal the pipe repair system together. The two connector pieces 610 and 620 are bonded to the broken pipe 110 and then the sleeve 130 is slide over the top to hold the two connector pieces 610 and 620 together. The two connector pieces 610 and 620, the sleeve 130, and the broken pipe 110 can all be glued together to form a water tight seal.

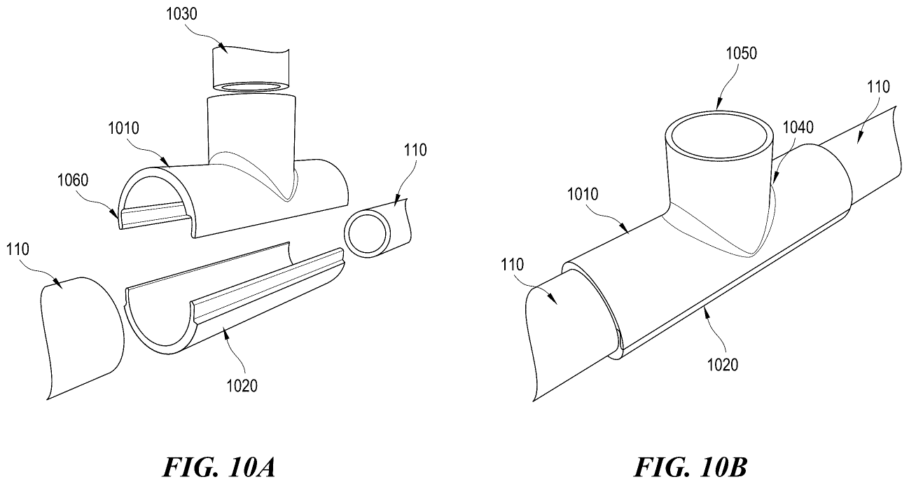

FIGS. 10A and 10B show a t-shaped connector 1010 for adding an additional branch to a cut pipe 110. According to an embodiment one of the two connector pieces is a t-shaped connector 1010 for connecting a new pipe to the existing pipe 110. The t-shaped connector 1010 can be in the shape of a T or a Y. The t-shaped connector 1010 mates with a connector piece 1020 in the shape of a half cylinder. The connector piece 1020 can have the same properties and shape as the connector pieces described in FIGS. 6A and 6B. The t-shaped connector 1010 and the connector piece 1020 snap together to create a seal around the cut pipe 110 when the connectors 1010 and 1020 are glued to the cut pipe 110 and to each other.

The t-shaped connector 1010 is a half cylinder in shape. It has tabs 1060 on the long edge where it mates with the connector piece 1020. A cutout 1040 is removed from the middle of the half cylinder of the t-shape connector 1010 to accommodate a branch piece 1050 that extends perpendicular from the half cylinder. The cutout 1040 and the branch piece 1050 can be circular in shape according to some embodiments. A new pipe 1030 that is added into the t-shaped connector 1010 is placed inside of the branch piece 1050. The branch piece 1050 has an inside diameter that is slightly larger than the outside diameter of the new pipe 1030.

The t-shaped connector 1010 allows a new pipe 1030 to be added to the existing pipe 110. The connectors 1010 and 1020 are added to an existing pipe 110 by cutting an opening in the existing pipe 110. The t-shape connector 1010 can point in any direction from the pipe 110 being repaired. The angle at which the new pipe 1030 extends can be any angle and the t-shaped connector 1010 can point in any direction to accommodate that angle. The t-shaped connector 1010 can take on more of a y-shape to accommodate the angle that the new pipe 1030 intersects the existing pipe 110. Additionally, the cross-sectional area of the new pipe 1030 can be any of a variety of sizes. The t-shaped connector 1010 can have different sized openings to accommodate the different sizes of new pipe 1030.

The t-shaped connector 1010 can be used with a connector piece 1020 or with a second t-shaped connector 1010. If two t-shaped connectors 1010 are used, then two new pipes 1030 can be added to the existing pipe 110.

The t-shaped connector 1010 and the connector piece 1020 are bonded to the existing pipe 110 and then the new pipe 1030 is bonded to the t-shaped connector 1010. Gluing the connections ensures a water tight seal between the existing pipe 1010, the t-shaped connector 1010, the connector piece 1020 and the new pipe 1030.

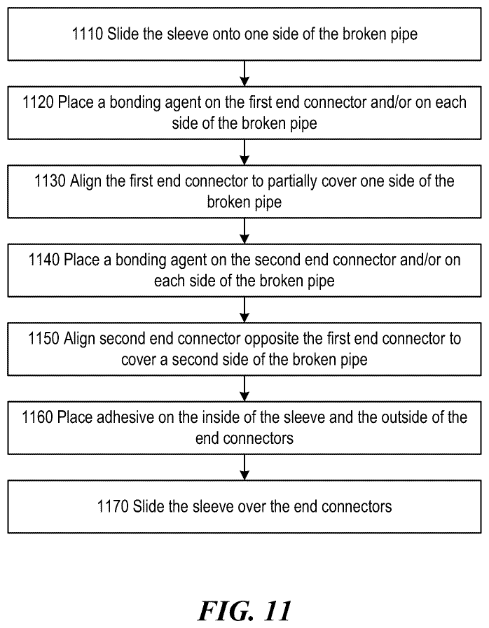

FIG. 11 describes a method for using the pipe repair system. A pipe that has been cut or that is broken is identified and the two halves of the broken or cut pipe are exposed for installation of the pipe repair system. At step 1110, slide the sleeve onto one side of the broken pipe. At step 1120, place a bonding agent on the first end connector and/or on each side of the broken pipe. At step 1130, align the first end connector to partially cover one side of the broken pipe. At step 1140, place a bonding agent on the second end connector and/or on each side of the broken pipe. At step 1150, align the second end connector opposite the first end connector to cover a second side of the broken pipe. At step 1160, place adhesive on the inside of the sleeve and the outside of the end connectors. At step 1170, slide the sleeve over the end connectors.

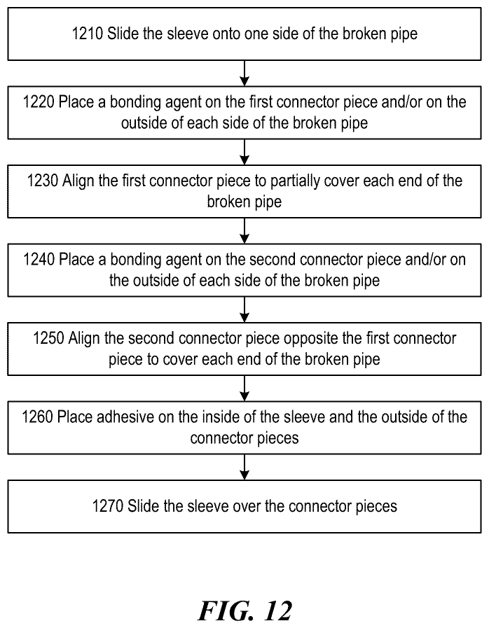

FIG. 12 describes a method for repairing a broken pipe using two connector pieces. A pipe that has been cut or that is broken is identified and the two halves of the broken or cut pipe are exposed for installation of the pipe repair system. At step 1210, slide the sleeve onto one side of the broken pipe. At step 1220, place a bonding agent on the first connector piece and/or on the outside of each side of the broken pipe. At step 1230, align the first connector piece to partially cover each end of the broken pipe. At step 1240, place a bonding agent on the second connector piece and/or on the outside of each side of the broken pipe. At step 1250, align the second connector piece opposite the first connector piece to cover each end of the broken pipe. At step 1260, place adhesive on the inside of the sleeve and the outside of the connector pieces. At step 1270, slide the sleeve over the connector pieces. Using a sleeve when installing the two connector pieces is optional. The two connector pieces can be used to repair a pipe without the sleeve and still form a secure repair.

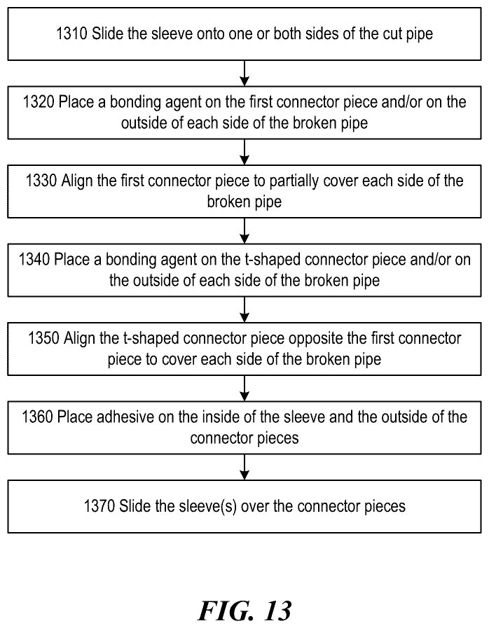

FIG. 13 describes a method for inserting a t-shaped connector into a pipe. A pipe that has been cut or that is broken is identified and the two halves of the broken or cut pipe are exposed for installation of the t-shaped connector. At step 1310, slide the sleeve onto one or both sides of the cut pipe. At step 1320, place a bonding agent on the first connector piece and/or on the outside of each side of the broken pipe. At step 1330, align the first connector piece to partially cover each side of the broken pipe. At step 1340, place a bonding agent on the t-shaped connector piece and/or on the outside of each side of the broken pipe. At step 1350, align the t-shaped connector piece opposite the first connector piece to cover each side of the broken pipe. At step 1360, place adhesive on the inside of the sleeve and the outside of the connector pieces. At step 1370, slide the sleeve(s) over the connector pieces. Using one or two sleeves when installing the t-shaped connector is optional. The t-shaped connector can be added onto an existing pipe without the sleeves and still form a secure connection.

Glues and bonding agents for joining the various parts of the pipe repair system can include a PVC cement, an epoxy adhesive, or any other suitable material for joining pipe sections. Alternatively, if the pipes are metal the pieces of the pipe repair system can be welded onto the existing pipe and welded to each other.

From the foregoing, it will be appreciated that specific embodiments of the invention have been described herein for purposes of illustration, but that various modifications may be made without deviating from the scope of the invention. Accordingly, the invention is not limited except as by the appended claims.

I/We claim:

1. A system for joining a plurality of pieces of pipe, comprising:
a first end connector;
a second end connector, each of the first end connector and the second end connector, including:
an outer cylindrical surface,
an inner cylindrical surface, the inner cylindrical surface widens on a first side from a center towards an outer side resulting in a concave shape, a second side, cylindrical in shape, having an inner diameter that is less than a diameter of the outer cylindrical surface;
a first circular end forming a lip on the first side; and
a second circular end on the second side; and
a cylindrical sleeve, comprising:
a single piece loop without seams;
an outer surface;
an inner surface, the inner surface having an inside diameter larger than an outside diameter of the outer cylindrical surface of the first end connector and the second end connector;
a first end; and
a second end,
wherein the first end and the second end have beveled edges;
the cylindrical sleeve surrounding the first end connector and the second end connector, spanning a space between the first end connector and the second end connector; and
whereby a sealed connection is made between the first end connector and the second end connector when the cylindrical sleeve surrounds the first end connector and the second end connector and a bonding agent is placed on the outer surface of the first end connector, the outer surface of the second end connector and the inner surface of the cylindrical sleeve.

2. The system of claim 1, wherein the first end connector, the second end connector and the cylindrical sleeve are comprised of plastic.

3. The system of claim 1, wherein the first end connector, the second end connector and the cylindrical sleeve are comprised of metal.

4. The system of claim 1, wherein the bonding agent is placed between the first end connector and a first pipe and between the second end connector and a second pipe.

5. The system of claim 1, wherein the beveled edges of the cylindrical sleeve enable the cylindrical sleeve to slide over the first end connector and the second end connector to surround the first end connector and the second end connector.

6. The system of claim 1, wherein the bonding agent is an adhesive including PVC cement, epoxy, glue, or a suitable material for joining the plurality of pieces of pipe.

7. The system of claim 1, wherein the plurality of pieces of pipe are comprised of plastic or metal.

8. A method for connecting a plurality of pieces of pipe, the method comprising:
attaching, via bonding agent, a first end connector to an end of a first piece of pipe and a second end connector to an end of a second piece of pipe, each of the first end connector and the second end connector, including:
an outer cylindrical surface,
an inner cylindrical surface, the inner cylindrical surface widens on a first side from a center towards an outer side resulting in a concave shape, a second side, cylindrical in shape, having an inner diameter that is less than a diameter of the outer cylindrical surface;
a first circular end forming a lip on the first side; and
a second circular end on the second side;
applying a bonding agent on the outer cylindrical surface of the first end connector, the outer cylindrical surface of the second end connector, and on an inner surface of a cylindrical sleeve, the cylindrical sleeve comprising:
a single piece loop without seams;
an outer surface;
an inner surface, the inner surface having an inside diameter larger than an outside diameter of the outer cylindrical surface of the first end connector and the second end connector;
a first end; and
a second end,
wherein the first end and the second end have beveled edges;
surrounding the first end connector and the second end connector with the cylindrical sleeve; and
whereby a sealed connection is made between the first end connector and the second end connector when the cylindrical sleeve surrounds the first end connector and the second end connector.

9. The method of claim 8, wherein the first end connector, the second end connector and the cylindrical sleeve are comprised of plastic.

10. The method of claim 8, wherein the first end connector, the second end connector and the cylindrical sleeve are comprised of metal.

11. The method of claim 8, wherein the bonding agent is placed between the first end connector and a first pipe and between the second end connector and a second pipe.

12. The method of claim 8, wherein the beveled edges of the cylindrical sleeve enable the cylindrical sleeve to slide over the first end connector and the second end connector to surround the first end connector and the second end connector.

13. The method of claim 8, wherein the bonding agent is an adhesive including PVC cement, epoxy, glue, or a suitable material for joining the plurality of pieces of pipe.

14. A system for joining a plurality of pieces of pipe, comprising:
a first end connector;
a second end connector, each of the first end connector and the second end connector, including:
an outer cylindrical surface,
an inner cylindrical surface, the inner cylindrical surface widens on a first side from a center towards an outer side resulting in a concave shape, a second side, cylindrical in shape, having an inner diameter that is less than a diameter of the outer cylindrical surface;
a first circular end forming a lip on the first side; and
a second circular end on the second side; and
a cylindrical sleeve, comprising:
an outer surface;
an inner surface, the inner surface having an inside diameter larger than an outside diameter of the outer cylindrical surface of the first end connector and the second end connector;
a first end; and
a second end;
the cylindrical sleeve surrounding the first end connector and the second end connector, spanning a space between the first end connector and the second end connector; and
whereby a sealed connection is made between the first end connector and the second end connector when the cylindrical sleeve surrounds the first end connector and the second end connector and a bonding agent is placed on the outer surface of the first end connector, the outer surface of the second end connector and the inner surface of the cylindrical sleeve.

15. The system of claim 14, wherein the first end connector, the second end connector and the cylindrical sleeve are comprised of plastic.

16. The system of claim 14, wherein the first end connector, the second end connector and the cylindrical sleeve are comprised of metal.

17. The system of claim 14, wherein the bonding agent is placed between the first end connector and a first pipe and between the second end connector and a second pipe.

18. The system of claim 14, wherein the cylindrical sleeve is a single piece loop without seams.

19. The system of claim 14, wherein the cylindrical sleeve has beveled edges enabling the cylindrical sleeve to slide over the first end connector and the second end connector to surround the first end connector and the second end connector.

20. The system of claim 14, wherein the bonding agent is an adhesive including PVC cement, epoxy, glue, or a suitable material for joining the plurality of pieces of pipe.
